(19) United States
(12) Patent Application Publication
(10) Pub. No.: US 2018/0312015 A1
(43) Pub. Date: Nov. 1, 2018

(54) Pneumatic Vehicle Tire

(71) Applicant: Continental Reifen Deutschland GmbH, Hannover (DE)

(72) Inventors: Norbert Kendziorra, Garbsen (DE); Christian Weber, Garbsen (DE)

(73) Assignee: Continental Reifen Deutschland GmbH, Hannover (DE)

(21) Appl. No.: 15/769,905

(22) PCT Filed: Jul. 4, 2016
(86) PCT No.: PCT/EP2016/065635

§ 371 Date: Apr. 20, 2018

(30) Foreign Application Priority Data
Oct. 21, 2015 (DE) 10 2015 220 492.8

(51) Int. Cl. B60C 19/08

(52) U.S. Cl. CPC B60C 19/088; B60C 2015/0614; B60C 19/084

(57) ABSTRACT

The invention relates to a pneumatic vehicle tire of a radial type of construction with a carcass (1) and a carcass turn-up (1a), wherein the carcass (1) and also the sidewall (5) consist of rubber compounds that are insufficiently electrically conductive, while the bead strip (7) consists of a rubber compound that is electrically conductive, and wherein at least the outer surface of the carcass (1) has electrically conductive, filament- or strip-shaped elements (12), which in the carcass turn-up (1a) lie radially on the inside. The invention is distinguished by the fact that an additional, electrically conductive component (9), which establishes a path of electrical conduction either from the one outer surface of the carcass (1) or from the inner surface of the carcass turn-up (1a) to the outer surface of the carcass turn-up (1a), is arranged on the end of the carcass turn-up (10).

The invention relates to a pneumatic vehicle tire of a radial type of construction with a carcass, with sidewalls, with carcass cores and with bead strips, wherein the carcass is led around the carcass cores from axially inside to axially outside and has a carcass turn-up, wherein the carcass together with the carcass turn-up and also the sidewalls comprise rubber compounds with optimized rolling resistance that are insufficiently electrically conductive, while the bead strips consist at least partially of a rubber compound that is electrically conductive, and wherein at least the radially outer surface of the carcass has electrically conductive elements, which in the region of the carcass turn-up lie radially on the inside, wherein these electrically conductive elements are formed as filaments or strips and are arranged spaced apart from one another and follow a radial path.

Such a pneumatic vehicle tire is known from DE 10 2010 017 443 A1. This tire has a reduced rolling resistance due to the use of low-rolling-resistance compounds. These are preferably used in the sidewall region, for the inner layer and the carcass. One of the ways in which the hysteresis of these low-rolling-resistance compounds can be reduced is by exchanging carbon black for silica. However, the use of these low-rolling-resistance compounds leads to an increase in the electrical resistance of these compounds, and so the electrical conductivity falls. The electrical resistance of the overall tire that is required by many automobile manufacturers for dissipating electrostatic charges, of at most 1×10 ⁸ Ω, cannot be ensured.

To allow the electrostatic charges that occur during the operation of the tire to be discharged, parts of the crown region that come into contact with the surface of the roadway and parts of the bead strips that come into contact with the tire rim are produced from electrically conductive rubber compounds. The electrical connection between the crown region and the bead strip is established by elements that are designed to be electrically conductive, here air discharging filaments, which are arranged on the surface of the carcass. In the tire, the electrically conductively designed air discharging filaments run in the radial direction and span the full width of the carcass ply, that is to say also in the region of the carcass turn-up. The electrically conductively designed air discharging filaments are not arranged close together, but spaced apart from one another.

The problem is thus that of ensuring the path of electrical conduction from the radially outer surface of the carcass to the electrically conductive bead strip. Even if the electrically conductively designed air discharging filaments are provided on both sides of the carcass surface, providing them spaced apart on the surface of the carcass does not ensure that the charge can be dissipated from the radially outer surface of the carcass to the radially outer surface of the carcass turn-up. This is so because the carcass has a certain thickness and the end face of the carcass turn-up has no electrically conducting elements.

“Electrically conductive” means that the tire has an electrical resistance of at most 1×10⁸ Ω.

“Insufficiently electrically conductive rubber compounds” are compounds with which the tire has an electrical resistance of >1×10⁸ Ω.

The term “crown region” means the components that are the tread, the breaker belt, the belt bandage and possible intermediate layers between the aforementioned components.

The invention is based on the object of providing an optimized-rolling-resistance pneumatic vehicle tire in which the dissipation of electrical charges is reliably ensured by means of simple measures.

The object is achieved according to the preamble and the characterizing features of claim 1 in that in the region of the end of the carcass turn-up there is arranged an additional, electrically conductive component, which lies directly on the carcass and establishes a path of electrical conduction either from the radially outer surface of the carcass or from the radially inner surface of the carcass turn-up to the radially outer surface of the carcass turn-up or to the bead strip.

It is essential to the invention that the dissipation of charges from the outer surface of the carcass or from the radially inner surface of the carcass turn-up to the radially outer surface of the carcass turn-up is ensured by the simple measure of an additional electrically conductive component.

“Additional, electrically conductive component” means here for example a component of rubber or a film that remains after evaporation of the solvent following application of an electrically conductive solution.

It is advantageous if the additional electrically conductive component is a rubber strip that runs around the circumference of the tire and consists of an electrically conductive rubber compound, preferably of a rubber compound containing carbon black.

It is advantageous if the additional electrically conductive component has a thickness of between 0.2 mm and 1.5 mm.

In one particular embodiment of the invention, only the radially outer surface of the carcass has electrically conductive elements, which in the carcass turn-up lie radially on the inside, and the additional electrically conductive component is either led from the radially outer surface of the carcass on the radially outer side of the carcass turn-up to the bead strip or is led from the radially inner surface of the carcass turn-up to the bead strip as a preferably asymmetrical wrap.

“Asymmetrical wrap” means a wrap comprising two elements of different lengths that extend from a common vertex.

In another embodiment of the invention, both the radially outer surface of the carcass and the radially inner surface of the carcass have electrically conductive elements and the additional electrically conductive component is either led from the radially outer surface of the carcass to the radially outer side of the carcass turn-up or is led from the radially inner surface of the carcass turn-up to the radially outer side of the carcass turn-up as a preferably symmetrical wrap.

“Symmetrical wrap” means a wrap comprising two elements of the same length that extend from a common vertex.

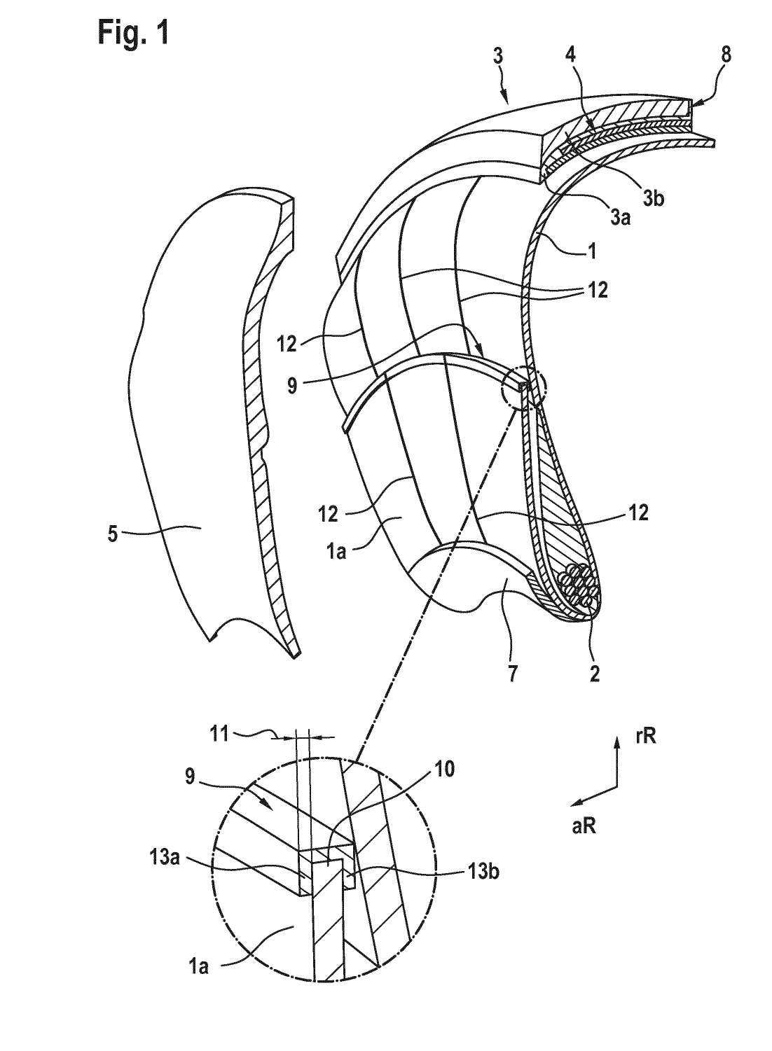

The invention is now explained in more detail on the basis of a schematic exemplary embodiment. FIG. 1 shows here a three-dimensional half cross section through a pneumatic vehicle tire according to the invention.

The pneumatic vehicle tire of a radial type of construction has a carcass 1, wherein the carcass 1 is led around bead cores 2 from axially inside to axially outside and ends in a carcass turn-up 1a. The pneumatic vehicle tire also has a tread 3 comprising a radially inner base 3a, a radially outer cap 3b and an electrically conductive so-called carbon center beam 8, a multi-ply breaker belt 4, sidewalls 5 (shown here as a component lifted off from the tire), an inner layer (not shown) and bead strips 7. The carcass 1, 1a, the tread cap 3b, the inner layer and also the sidewalls 5 consist of rubber compounds with optimized rolling resistance that are insufficiently electrically conductive. The bead strip 7, the breaker belt 4 and also the carbon center beam 8 integrated in the tread 3 and the tread base 3a consist of rubber compounds that are electrically conductive.

To allow the electrostatic charges that occur during the operation of the vehicle to be discharged, there must be a path of electrical conduction from the crown region that comes into contact with the roadway to the bead strip 7 that come into contact with the tire rim. Because the carcass 1, 1a and the sidewall 5 are only insufficiently electrically conductive, the conductivity is established by electrically conductively designed filaments, preferably air discharging filaments 12, which are arranged on the surface of the carcass 1, 1a. In this embodiment of the invention, electrically conductively designed filaments 12 are provided on both surfaces of the carcass 1, 1a (both the radially outer surface and the radially inner surface). In an alternative embodiment of the invention, it is possible that only the radially outer surface of the carcass 1, 1a has the electrically conductively designed filaments. It is shown here that both surfaces of the carcass have the electrically conductively designed filaments 12.

To ensure a path of electrical conduction from the carcass 1, 1a to the bead strip 7, an additional, electrically conductive component 9 is arranged in the region of the end 10 of the carcass turn-up 1a. This additional electrically conductive component 9 lies directly on the carcass 1, 1a and establishes a path of electrical conduction from the radially inner surface of the carcass turn-up 1a to the radially outer surface of the carcass turn-up 1a. The additional electrically conductive component 9 extends around the end 10 of the carcass turn-up 1a as a symmetrical wrap with two elements 13a, 13b of the same length and spans the nonconductive end face of the end 10 of the carcass turn-up 1a. Arranged on the outer surface of the carcass turn-up 1a are the electrically conductively designed filaments 12, which establish the electrical connection to the bead strip 7. When the tire is fitted onto a rim ready for operation, the bead strip 7 comes into contact with the rim.

The additional electrically conductive component 9 is a rubber strip that runs around the circumference of the tire and consists of an electrically conductive rubber compound, preferably of a rubber compound containing carbon black. The component 9 has a thickness 11 of between 0.2 mm and 1.5 mm.

### LIST OF REFERENCE SIGNS

(Part of the Description)

1 Carcass

1a Carcass turn-up

2 Bead core

3 Tread

3a Tread base

3b Tread cap

4 Breaker belt

5 Sidewall

7 Bead strip

8 Carbon center beam

9 Additional electrically conductive component

10 End of the carcass turn-up

11 Thickness of the additional electrically conductive component

12 Electrically conductive (air discharging) filament

13a Element

13b Element

aR Axial direction

rR Radial direction

1-5. (canceled)

6. A pneumatic vehicle tire of a radial type of construction which comprises a carcass and a sidewall, wherein a bead is disposed around bead cores from axially inside to axially outside of the carcass, and wherein the bead provides a carcass turn-up and a bead strip;
wherein the carcass and the sidewall comprise rubber compounds that are insufficiently electrically conductive, while the bead strip is comprised at least partially of a rubber compound that is electrically conductive, wherein at least a radially outer surface of the carcass comprises electrically conductive elements, which, in the carcass turn-up lie radially on an inside, and
wherein the electrically conductive elements are formed as filaments or strips which are arranged spaced apart from one another while following a radial path; and, wherein in a region of an end of the carcass turn-up there is disposed an additional electrically conductive component, which lies directly on the carcass and establishes a path of electrical conduction from the radially outer surface of the carcass.

7. The pneumatic vehicle tire as claimed in claim 6 further comprising a second additional electrically conductive component which is a rubber strip disposed around a circumference of the pneumatic vehicle tire, wherein the second additional electrically conductive component comprises an electrically conductive rubber compound.

8. The pneumatic vehicle tire as claimed in claim 7, wherein the electrically conductive rubber compound comprises carbon black.

9. The pneumatic vehicle tire as claimed in claim 7, wherein the second additional electrically conductive component has a thickness of between 0.2 mm and 1.5 mm.

10. The pneumatic vehicle tire as claimed in claim 6, wherein only the radially outer surface of the carcass comprises electrically conductive elements, which in the carcass turn-up lie radially on the inside, and wherein the additional electrically conductive component is disposed either from the radially outer surface of the carcass on the radially outer side of the carcass turn-up to the bead strip, or, from the radially inner surface of the carcass turn-up to the bead strip as an asymmetrical wrap.

11. The pneumatic vehicle tire as claimed in claim 6, wherein both the radially outer surface of the carcass and the radially inner surface of the carcass comprise electrically conductive elements, and wherein the additional electrically conductive component is disposed either from the radially outer surface of the carcass to the radially outer side of the carcass turn-up, or, from the radially inner surface of the carcass turn-up to the radially outer side of the carcass turn-up as a symmetrical wrap.

12. A pneumatic vehicle tire of a radial type of construction which comprises a carcass and a sidewall, wherein a bead is disposed around bead cores from axially inside to axially outside of the carcass, and wherein the bead provides a carcass turn-up and a bead strip;
wherein the carcass and the sidewall comprise rubber compounds that are insufficiently electrically conductive, while the bead strip is comprised at least partially of a rubber compound that is electrically conductive, wherein at least a radially outer surface of the carcass comprises electrically conductive elements, which, in the carcass turn-up lie radially on an inside, and wherein the electrically conductive elements are formed as filaments or strips which are arranged spaced apart from one another while following a radial path; and,
wherein in a region of an end of the carcass turn-up there is disposed an additional electrically conductive component, which lies directly on the carcass and establishes a path of electrical conduction from a radially inner surface of the carcass turn-up to the radially outer surface of the carcass turn-up.

13. The pneumatic vehicle tire as claimed in claim 12 further comprising a second additional electrically conductive component which is a rubber strip disposed around a circumference of the pneumatic vehicle tire, wherein the second additional electrically conductive component comprises an electrically conductive rubber compound.

14. The pneumatic vehicle tire as claimed in claim 13, wherein the electrically conductive rubber compound comprises carbon black.

15. The pneumatic vehicle tire as claimed in claim 13, wherein the second additional electrically conductive component has a thickness of between 0.2 mm and 1.5 mm.

16. The pneumatic vehicle tire as claimed in claim 12, wherein only the radially outer surface of the carcass comprises electrically conductive elements, which in the carcass turn-up lie radially on the inside, and wherein the additional electrically conductive component is disposed either from the radially outer surface of the carcass on the radially outer side of the carcass turn-up to the bead strip, or, from the radially inner surface of the carcass turn-up to the bead strip as an asymmetrical wrap.

17. The pneumatic vehicle tire as claimed in claim 12, wherein both the radially outer surface of the carcass and the radially inner surface of the carcass comprise electrically conductive elements, and wherein the additional electrically conductive component is disposed either from the radially outer surface of the carcass to the radially outer side of the carcass turn-up, or, from the radially inner surface of the carcass turn-up to the radially outer side of the carcass turn-up as a symmetrical wrap.

18. A pneumatic vehicle tire of a radial type of construction which comprises a carcass and a sidewall, wherein a bead is disposed around bead cores from axially inside to axially outside of the carcass, and wherein the bead provides a carcass turn-up and a bead strip;
wherein the carcass and the sidewall comprise rubber compounds that are insufficiently electrically conductive, while the bead strip is comprised at least partially of a rubber compound that is electrically conductive, wherein at least a radially outer surface of the carcass comprises electrically conductive elements, which, in the carcass turn-up lie radially on an inside, and
wherein the electrically conductive elements are formed as filaments or strips which are arranged spaced apart from one another while following a radial path; and,
wherein in a region of an end of the carcass turn-up there is disposed an additional electrically conductive component, which lies directly on the carcass and establishes a path of electrical conduction to the bead strip.

19. The pneumatic vehicle tire as claimed in claim 18 further comprising a second additional electrically conductive component which is a rubber strip disposed around a circumference of the pneumatic vehicle tire, wherein the second additional electrically conductive component comprises an electrically conductive rubber compound.

20. The pneumatic vehicle tire as claimed in claim 19, wherein the electrically conductive rubber compound comprises carbon black.

21. The pneumatic vehicle tire as claimed in claim 19, wherein the second additional electrically conductive component has a thickness of between 0.2 mm and 1.5 mm.

22. The pneumatic vehicle tire as claimed in claim 18, wherein only the radially outer surface of the carcass comprises electrically conductive elements, which in the carcass turn-up lie radially on the inside, and wherein the additional electrically conductive component is disposed either from the radially outer surface of the carcass on the radially outer side of the carcass turn-up to the bead strip, or, from the radially inner surface of the carcass turn-up to the bead strip as an asymmetrical wrap.

23. The pneumatic vehicle tire as claimed in claim 18, wherein both the radially outer surface of the carcass and the radially inner surface of the carcass comprise electrically conductive elements, and wherein the additional electrically conductive component is disposed either from the radially outer surface of the carcass to the radially outer side of the carcass turn-up, or, from the radially inner surface of the carcass turn-up to the radially outer side of the carcass turn-up as a symmetrical wrap.
